(19) United States
(12) Patent Application Publication
(10) Pub. No.: US 2013/0127399 A1
(43) Pub. Date: May 23, 2013

(54) CELL BALANCING SYSTEM AND METHOD

(71) Applicants: Xidong TANG, Royal Oak, MI (US); Lei HAO, Troy, MI (US); Xiaofeng MAO, Warren, MI (US); Jyh-Shin CHEN, Troy, MI (US)

(72) Inventors: Xidong TANG, Royal Oak, MI (US); Lei HAO, Troy, MI (US); Xiaofeng MAO, Warren, MI (US); Jyh-Shin CHEN, Troy, MI (US)

(73) Assignee: GM GLOBAL TECHNOLOGY OPERATIONS LLC, Detroit, MI (US)

(21) Appl. No.: 13/300,853

(22) Filed: Nov. 21, 2011

(51) Int. Cl. H02J 7/00

(52) U.S. Cl. 320/104; 320/103

(57) ABSTRACT

A system and method may identifying an overcharged cell from among a plurality of cells of a battery pack. An undercharged cell may be identified from among any of the plurality of cells of the battery pack. A switch may be operated to connect the overcharged cell to the undercharged cell via a direct current (DC)-DC converter. The DC-DC converter may be operated to transfer charge from the overcharged cell to the undercharged cell.

### FIELD OF THE INVENTION

The present invention is related to a method for cell balancing for a battery, for example, of an electrically powered vehicle.

### BACKGROUND

Rechargeable batteries are designed to provide electrical power to a system, such as to an electrically powered or hybrid vehicle. When the electrical energy stored in the battery is fully or partially depleted, the battery may be recharged by an appropriate charging device (e.g. by connection to a power grid or by a generator on board a vehicle and powered by components of the vehicle). A typical rechargeable battery includes an array of electric power cells in the form of a battery pack. Often, individual cells of the battery pack may slightly differ in their properties from one another. Different cells of the battery pack may be charged or discharged at different rates during charging or providing power. Such differences charging or discharging rates may result in cell-to-cell differences of a state of charge (SOC) of the cells, as indicated by, for example, a voltage of the cell. Such differences may reduce efficiency of the cell, may shorten the useful lifetime of the battery pack, or may result in damage to the battery pack or to a system to which the battery pack is connected. For this reason, battery packs are often provided with circuitry to enable cell balancing. In cell balancing, cells are charged or discharged with the goal of attaining a uniform SOC for all of the cells. Circuitry for some cell balancing techniques may add appreciable weight to the battery pack, which may be disadvantageous when the battery pack is intended to be incorporated in a portable device or a vehicle. Implementation of some methods of cell balancing may result in appreciable dissipative loss of electrical energy.

Thus, there is a need for a method for cell balancing that may be implemented with relatively light circuitry and with minimal dissipative loss of energy.

### SUMMARY

There is thus provided, in accordance with an embodiment of the invention, a method including identifying an overcharged cell from among a plurality of cells of a battery pack; identifying an undercharged cell from among any of the plurality of cells of the battery pack; operating a switch to connect the overcharged cell to the undercharged cell via a direct current (DC)-DC converter; and operating the DC-DC converter to transfer charge from the overcharged cell to the undercharged cell.

An embodiment of the invention may include, selecting a cell from among cells of a battery pack; determining an SOC of the selected cell; if the SOC of the selected cell is different from a representative SOC of the cells of the battery pack, operating a switch to connect the selected cell to a charge source/sink via a DC-DC converter; if the SOC of the selected cell is greater than the representative SOC, operating the DC-DC converter to discharge the selected cell to the charge source/sink; and if the SOC of the selected cell is less than the representative SOC, operating the DC-DC converter to charge the selected cell from the charge source/sink.

An embodiment of the invention includes a plurality of switches; a direct current (DC)-DC converter; and a controller to identify an overcharged cell from among a plurality of cells of a battery pack, to identify an undercharged cell from among any of the plurality of cells of the battery pack, to operate at least a switch of the plurality of switches to connect the overcharged cell to the undercharged cell via the DC-DC converter, and operate the DC-DC converter to transfer charge from the overcharged cell to the undercharged cell.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic diagram of a vehicle with a battery pack that is configured for cell balancing in accordance with an embodiment of the present invention;

FIG. 2 is a schematic diagram of a system for self-supporting active cell balancing, in accordance with an embodiment of the present invention;

FIG. 3 is a flowchart of a method for self-supporting active cell balancing, in accordance with an embodiment of the present invention;

FIG. 4 is a flowchart of an example of the method for self-supporting active cell balancing shown in FIG. 3, in accordance with an embodiment of the present invention;

FIG. 5 is a schematic diagram of a system for active cell balancing via a charge source/sink, in accordance with an embodiment of the present invention;

FIG. 6 is a flowchart of a method for active cell balancing via a charge source/sink, in accordance with an embodiment of the present invention;

FIG. 7 is a schematic diagram of a system for active cell balancing utilizing an ultra-capacitor, in accordance with an embodiment of the present invention;

FIG. 8 is a flowchart of a method for active cell balancing using an ultra-capacitor, in accordance with an embodiment of the present invention;

FIG. 9 is a schematic diagram of a system for active cell balancing utilizing an ultra-capacitor connected to a low voltage (LV) bus, in accordance with an embodiment of the present invention;

FIG. 10 is a flowchart of a method for active cell balancing using an ultra-capacitor connected to an LV bus, in accordance with an embodiment of the present invention;

FIG. 11A is a schematic diagram of a system for active cell balancing utilizing an LV bus, in accordance with an embodiment of the present invention;

FIG. 11B is a schematic diagram of an embodiment of the system for active cell balancing utilizing an LV bus shown in FIG. 11A;

FIG. 12 is a flowchart of a method for active cell balancing using an LV bus, in accordance with an embodiment of the present invention; and

FIG. 13 is a schematic diagram of a system for active cell balancing utilizing a high voltage (HV) bus, in accordance with an embodiment of the present invention.

Reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. It will however be understood by those of ordinary skill in the art that the embodiments of the present invention may be practiced without these specific details. In other instances, well-known methods, procedures, components, and circuits have not been described in detail so as not to obscure the present invention.

Unless specifically stated otherwise, as apparent from the following discussions, throughout the specification discussions utilizing terms such as “processing”, “computing”, “storing”, “determining”, “evaluating”, “measuring”, “providing”, “transferring”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In accordance with embodiments of the present invention, active battery cell balancing may be applied to cells of a battery pack. The active cell balancing may transfer charge to (or increase the voltage of or increase the energy stored in) a cell of the battery pack whose state of charge (SOC) is less than a characteristic or representative (e.g. average) SOC of the battery pack (e.g. an average SOC of the cells of the battery pack). The representative SOC may be determined periodically, e.g. prior to when beginning execution of a cell balancing method. For example, an average cell SOC may be determined by measuring an overall SOC (e.g. via a voltage and current measurement) of the battery pack and dividing the overall SOC by the number of cells. As another example, an average SOC may be determined from individual SOC-related measurements on the cells of the battery pack. The active cell balancing may remove charge from (or decrease the voltage of or remove energy from) a cell whose SOC is greater than the characteristic SOC. The SOC of a cell may be derived from, or related to, a measured voltage of the cell, or from another quantity that may be indicative of the SOC. References herein to SOC should be understood as referring to any quantity whose measured value is indicative of the SOC.

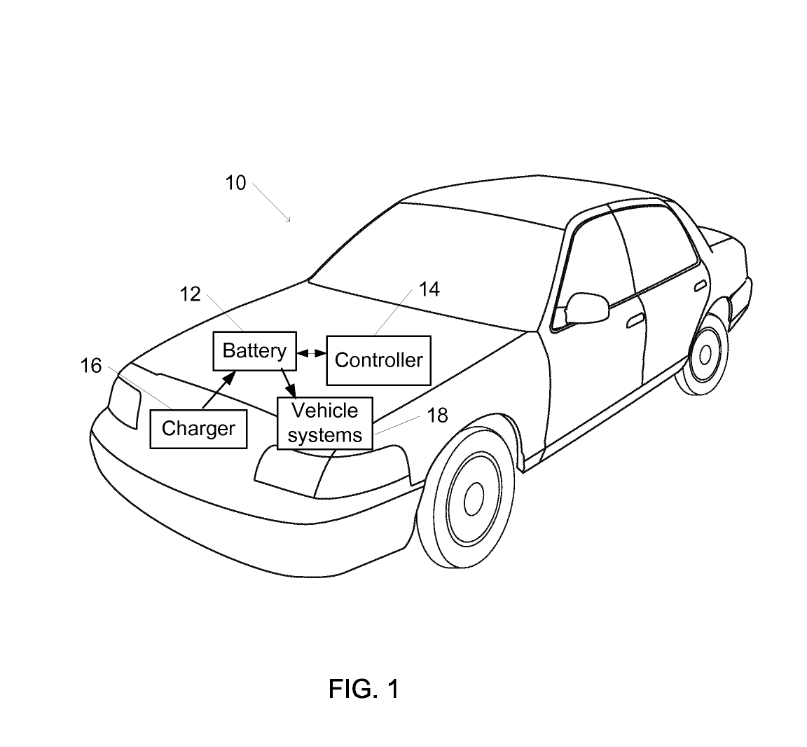

FIG. 1 is a schematic diagram of a vehicle with a battery pack that is configured for cell balancing in accordance with an embodiment of the present invention. Vehicle 10 may represent a vehicle that is fully or partially powered by electrical power that is provided by battery 12. For example, vehicle 10 may be an electrically powered, or a hybrid, automobile. Although FIG. 1 shows battery 12 as associated with a vehicle, embodiments of the present invention may be applied in any system that incorporates or is powered by a rechargeable battery pack of individual power cells.

Battery 12, as described below, includes a plurality of cells, each characterizable by an SOC, and circuitry for enabling cell balancing. Each cell may typically include a closed device with an externally accessible cathode and anode, and may be at least partially filled with an electrolyte material. For example, the cells may include lithium-ion cells. Other structures may be used. Battery 12 may be located in a battery compartment that is located in vehicle 10, e.g. in a forward or rear engine or storage compartment, or under a seat.

Controller 14 may monitor and control operation of battery 12 in accordance with programmed instructions. Controller 14 may be a controller or processor whose function is limited to monitoring and controlling operation of battery 12, or may represent a controller that controls additional systems of vehicle 10. Controller 14 may represent a single computer or circuit, or two or more cooperating computers, circuits, or processors. Among other functions, controller 14 may be configured to receive signals that indicate an SOC of one or more cells of battery 12, and control operation of cell balancing circuitry in accordance with the received signals.

Charger 16 may be operated to charge or recharge cells of battery 12. For example, charger 16 may be connectable to an external electrical power grid, or a generator that is incorporated in vehicle 10. For example, a generator of vehicle 10 may be powered by a non-electrically powered engine of vehicle 10 (e.g. an internal combustion engine), or by a braking system of vehicle 10. Operation of charger 16, or transfer of charge from charger 16 to battery 12, may be controlled by controller 14.

Electrical power from battery 12 may be utilized to operate one or more components or systems of vehicle 10. The components and systems of vehicle 10 are represented collectively by vehicle systems 18. For example, vehicle systems 18 may represent one or more of: an electrically power motor for driving vehicle 10, illumination components, an ignition system for an internal combustion engine, a control panel, a heating or cooling system, an audio or audio/visual entertainment or communication system, window and door operation, a navigation system, or an onboard computer.

In accordance with some embodiments of the present invention, self-supporting active battery cell balancing may be applied to balance the SOC of cells of a battery pack. For example, a controller may identify a cell whose SOC is lower than the representative SOC of the battery pack, and another whose SOC is greater than the representative SOC. The controller may then operate a self-supporting active cell balancing circuit in order to transfer charge from the identified cell with greater SOC to the identified cell with lower SOC.

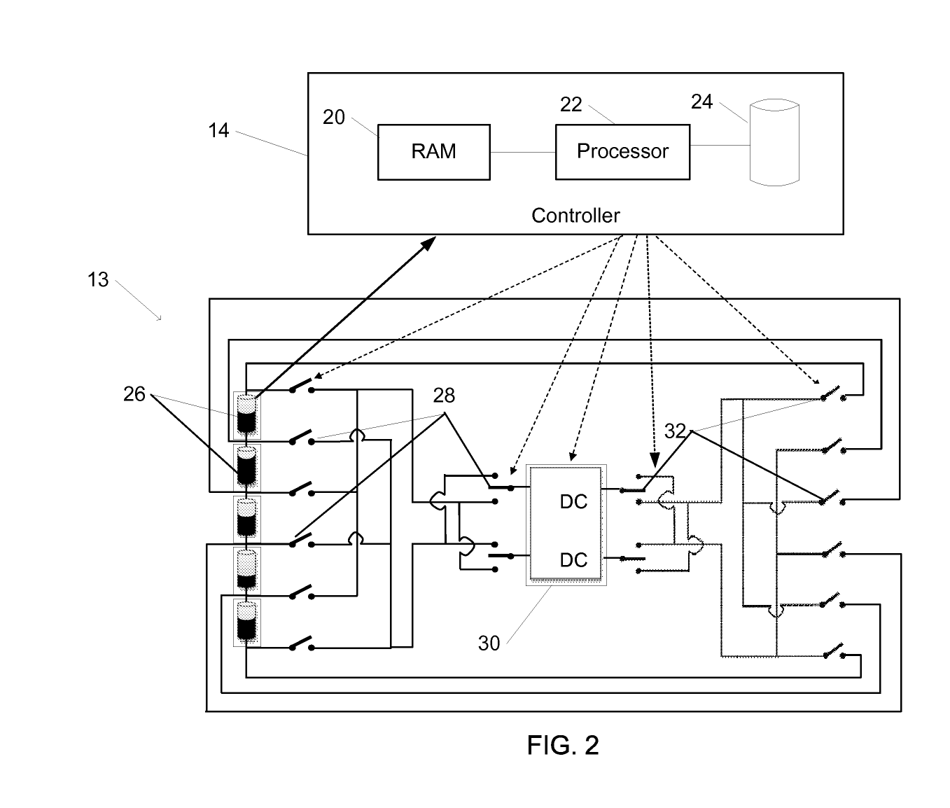

FIG. 2 is a schematic diagram of a system for self-supporting active cell balancing, in accordance with an embodiment of the present invention.

Self-supporting battery 13 includes an array of cells 26. Cells 26 are chargeable and may be selectively connected to a connector of direct current (DC)-DC converter 30 via operation of switches 28 and 32. DC-DC converter 30 may include a low voltage DC-DC converter. Switches 28 and 32 may include, for example, low-voltage metal-oxide-semiconductor field-effect transistor (MOSFET) switches or relays or an insulated gate bipolar transistor (IGBT). Switches 28 and 32 may also be operated to connect cells 26 to a connection to an external system or charger. Such a connection may enable self-supporting battery 13 to provide power to the external system, or to be charged by the charger.

Switches 28 and 32, as well as DC-DC converter 30, may be operable or controllable by controller 14. DC-DC converter 30 includes at least two connectors for connecting (via operation of switches 28 and 32) to various elements of self-supporting battery 13. Controller 14 may include a processor 22 which is configured operate in accordance with programmed instructions. Such programmed instructions may include instructions for operating switches 28 to connect one cell 26 individually to one connector (or set of connectors) of DC-DC converter 30, and switches 32 so as to connect another cell 26 individually to a different connector (or set of connectors) of DC-DC converter 30. Thus, any two cells 26 may be connected to one another via DC-DC converter 30.

Processor 22 may communicate with data storage device 24. Data storage device or long-term storage 24 may include one or more non-volatile devices that that are capable of storing data, such as a hard disk drive, or other device. Such data may include programming instructions. In addition, processor 22 may communicate with a memory device for storing data during operation, represented by memory or random access memory (RAM) 20.

Processor 22 may be, for example, a central processing unit (CPU), a chip or any suitable computing or computational device. Processor 22 may include multiple processors, and may include general-purpose processors and/or dedicated processors such as graphics processing chips. Processor 22 may execute code or instructions, for example, stored in memory 20 or long-term storage 24, to carry out embodiments of the present invention.

Controller 14 may be configured to identify a cell 26 whose SOC is different from, e.g. greater or less than, the representative SOC of self-supporting battery 13. A cell 26 may be referred to as overcharged when its SOC is greater than the representative SOC of self-supporting battery 13, and as undercharged when its SOC is less than the representative SOC. Upon identifying an overcharged or undercharged SOC, controller 14 may be configured to identify a cell 26 in the opposite state (undercharged or overcharged respectively). Upon identifying or selecting such a pair of cells 26 in opposite states, controller 14 may be configured to control switches 28 and 32 so as to connect the cells 26 of the pair to one another, for example, via DC-DC converter 30. DC-DC converter 30 may then be controlled or operated to transfer charge from the overcharged cell 26 of the pair (discharge the cell) to the undercharged cell 26 of the pair, to charge the undercharged cell 26. For example, a discharge current and time may be set so as to bring the SOC of one or both cells 26 of the pair to the representative SOC (or to within a threshold of the representative SOC, or substantially equal to the representative SOC). In this manner, by charging once cell from another cell, from the source/sink, the SOC of each cell 26 of the pair may be brought closer to the representative SOC of self-supporting battery 13.

A system with a battery configured as self-supporting battery 13 may provide for greater efficiency and more flexibility than other cell balancing systems. For example, self-supporting battery 13 may enable any one of cells 26 to be connected (e.g., via DC-DC converter 30) to any other of cells 26. No predetermined limitations are imposed on the connections, and such flexibility may enable optimizing the transfer of charge and the efficiency of the cell balancing. Self-supporting battery 13 may contain a minimal amount of resistors or energy storage devices, minimizing dissipative losses. In the absence of an excess amount of heat generated by dissipative losses, cell balancing may proceed at a faster rate than otherwise. Thus, cell balancing may be performed on a continual basis, concurrent with vehicle operation.

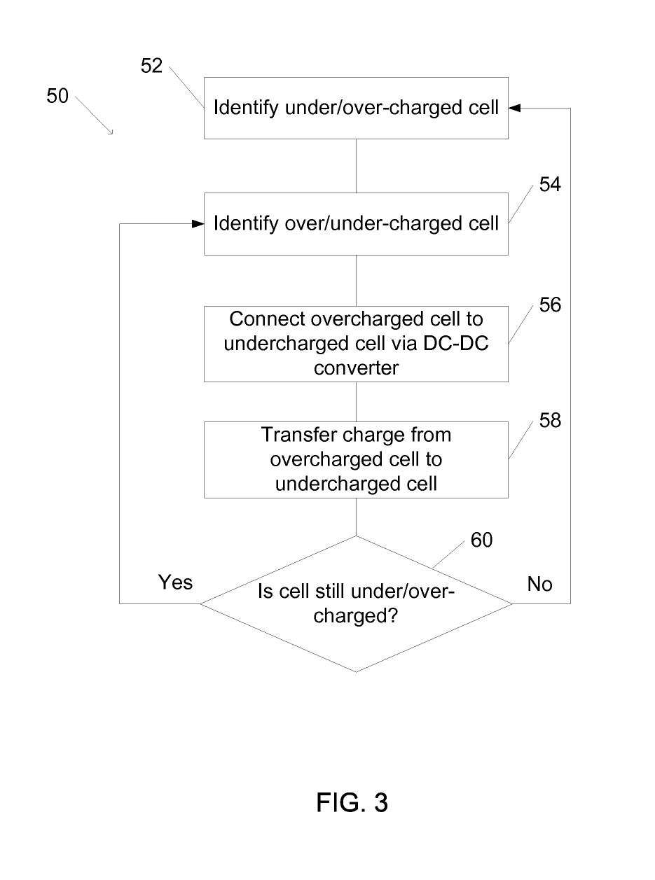

FIG. 3 is a flowchart of a method for self-supporting active cell balancing, in accordance with an embodiment of the present invention.

It should be understood with regard to the flowchart in FIG. 3 and in the other accompanying figures that the division of the illustrated methods into discrete blocks or steps has been selected for convenience only, and that alternative division into steps is possible with equivalent results. Such alternative division into steps or blocks should be considered as falling within the scope of embodiments of the present invention. It should also be understood that, unless stated otherwise, the order of steps or blocks as shown has been selected for clarity of the discussion. Steps of the illustrated method may be performed in an alternative order or concurrently with equivalent results. Such reordering of the steps or blocks should be understood as falling within the scope of embodiments of the present invention.

Cell balancing method 50 may be executed by a controller (e.g., controller 14, processor 22, or another device) that is configured to monitor cells of a battery pack and to control the state of switches within the battery pack. Cell balancing method 50 includes identifying a cell of a battery pack that is overcharged or undercharged (block 52). For example, a search technique may be applied that includes measuring the SOC of each cell being searched. Another cell of the battery pack may be identified whose SOC deviates from the representative battery SOC in the opposite direction (block 54). For example, if the first cell that was identified is overcharged, then a second cell is identified that is undercharged. On the other hand, if the first cell was undercharged, then a second cell is identified that is overcharged.

The controller may then control or operate switches within the battery pack so as to connect the first identified cell to the second identified cell for example via a DC-DC converter (block 56). The DC-DC converter may be controlled or operated to transfer charge from the identified cell that was overcharged (discharging the cell) to charge the identified cell that was undercharged (block 58). Typically, the DC-DC converter is operated at such current level and for such a time as to change the SOC of whichever (the overcharged or the undercharged) cell is closer to the representative SOC to the representative SOC.

The controller may then measure the SOC of the cell whose SOC was further from the representative SOC (block 60). If the cell remains overcharged or undercharged, another second cell may be identified and charge may be transferred (returning to block 54). On the other hand, if the SOC of the cell is no longer significantly different or substantially unequal from the representative SOC of the battery pack (e.g. the cell SOC is within a threshold of the representative SOC), another overcharged or undercharged cell may be identified, and the process repeated (returning to block 52).

Cell balancing method 50 may be performed automatically, for example, at predetermined periods (e.g. periodically at predetermined time intervals), or in response to predetermined conditions (e.g. turning on a vehicle, recharging the vehicle, performance of a diagnostic test, or traveling a predetermined distance). Cell balancing method 50 may also be initiated by an operator (e.g. a repair technician).

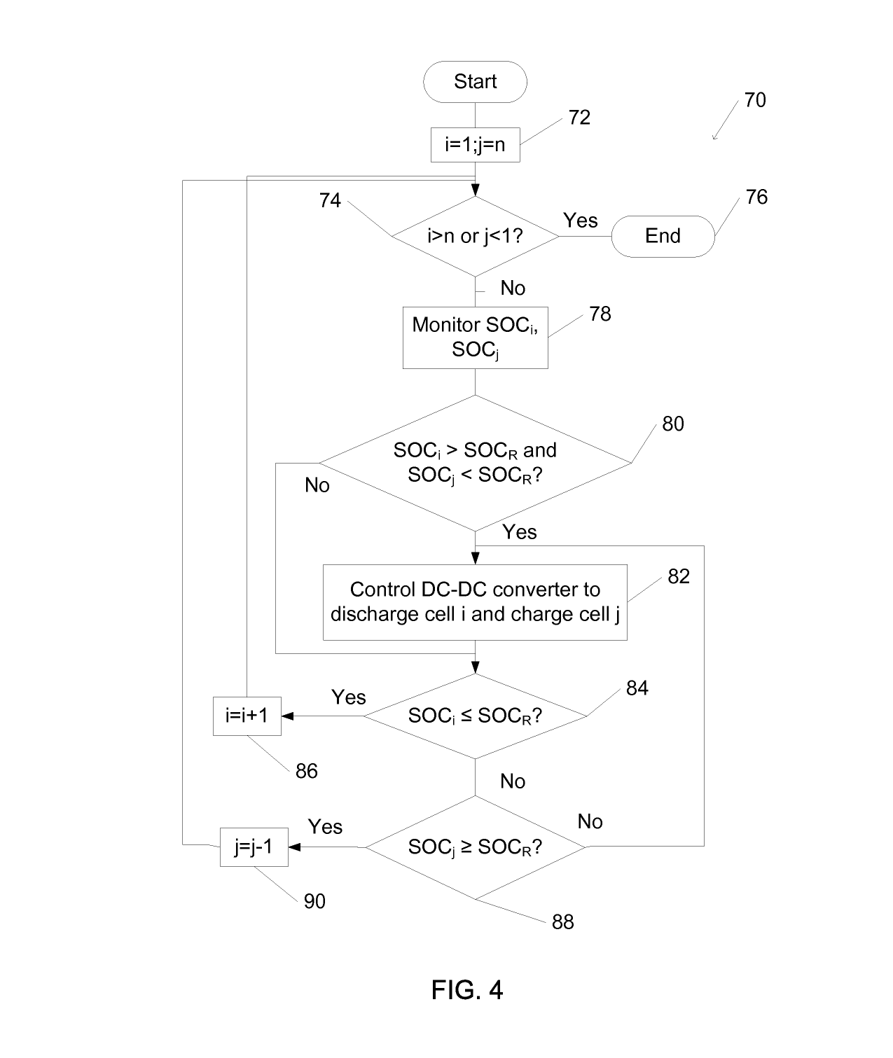

FIG. 4 is a flowchart of an example of the method for self-supporting active cell balancing shown in FIG. 3, in accordance with an embodiment of the present invention. In accordance with cell balancing method 70, a controller monitors or measures the state of sequentially or iteratively selected pairs of cells in order to identify overcharged and undercharged cells. The monitoring may be sequential or iterative. The controller may iterate through a series of pairs of cells.

Two indices, i and j, are initialized to, for example, 1 and to n (the total number of cells in the battery pack), respectively (block 72). If at any point i exceeds n, or j is less than 1 (block 74—indicating that all cells have been examined), cell balancing method ends (block 76). In accordance with cell balancing method 70, execution of the loop over index i is intended to identify overcharged cells for the purpose of discharging them, while the loop over index j is intended to identify undercharged cells for the purpose of charging them. When a pair of cells that includes one overcharged and one undercharged cell is identified, the overcharged cell may be discharged while concurrently charging the undercharged cell.

The SOC of the cells indexed by i and j, SOCᵢ and SOCⱼ respectively, are monitored or otherwise measured (block 78). Assignment of an index to each of the cells may be such so as to facilitate cell balancing or to optimize the speed of execution of cell balancing method 70, may be selected in an order determined by a physical arrangement of the cells, or in any other order.

A representative SOC of the battery pack may be indicated by SOC_{R}. SOCᵢ may be greater than SOC_{R} (is overcharged) and SOCⱼ may be less than SOC_{R} (is undercharged—block 80). In this case, switches and a DC-DC converter may be controlled so as to discharge cell i and concurrently charge cell j, thus transferring charge from cell i to cell j (block 82).

Whether or not charge was transferred, SOCᵢ may be compared with SOC_{R} (block 84). If SOCᵢ is less than or equal to SOC_{R}, indicating that cell i need not be discharged (e.g. was never overcharged or the overcharge was corrected by discharging), the index i is incremented (block 86), and the process repeated for a cell with a new index i (returning to block 74). The cell corresponding to incremented index i may then be connected to the cell corresponding to index j and the DC-DC converter controlled. Otherwise, cell balancing method 70 continues to search for another cell j to which to transfer the excess charge of cell i.

Whether or not charge was transferred, SOCⱼ may be compared with SOC_{R} (block 88). If SOCⱼ is greater than or equal to SOC_{R}, indicating that cell j need not be charged (e.g. was never undercharged or the undercharge was corrected by charging), the index j is decremented (block 90), and the process repeated for a cell with a new index j (returning to block 74). The corresponding to decremented index j may then be connected to the cell corresponding to index i and the DC-DC converter controlled. Otherwise, cell balancing method 70 continues to search for another cell i from which to transfer charge in order to charge cell j.

In accordance with some embodiments of the present invention, switches of the battery pack may be controlled to individually connect each cell of the battery pack to, for example, an electrical charge source/sink via a DC-DC converter. The DC-DC converter may be controlled to transfer charge from an overcharged cell to the charge source/sink, or to transfer charge from the charge source/sink to an undercharged cell. For example, such a charge source/sink may include an ultra-capacitor (UC), a low voltage (LV) bus, a high voltage (HV) bus, or a combination of these. As another example, another cell may of the battery may temporarily (e.g. during the time that it is connected to the overcharged or undercharged cell via the DC-DC converter) serve as charge source/sink.

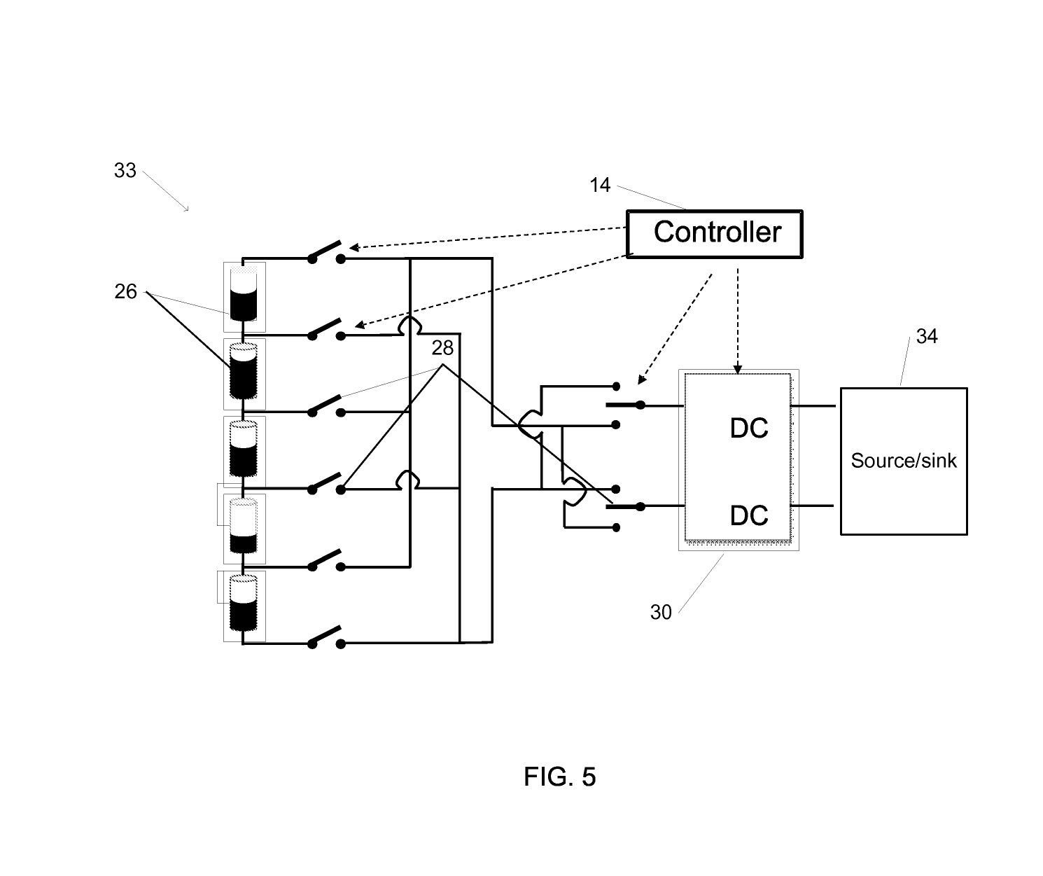

FIG. 5 is a schematic diagram of a system for active cell balancing via a charge source/sink, in accordance with an embodiment of the present invention.

Source/sink battery 33 includes charge source/sink 34. Switches 28 are controllable by controller 14 to connect at least one of cells 26 to charge source/sink 34 (e.g. a UC, an LV bus, or an HV bus) via DC-DC converter 30. DC-DC converter 30 may be controlled in conjunction with switches 28 to discharge a cell 26, transferring the charge to charge source/sink 34, e.g. when the cell 26 is overcharged. Similarly, DC-DC converter 30 and switches 28 may be controlled to draw charge from charge source/sink 34 while charging a cell 26, e.g. when the cell 26 is undercharged. Thus, by monitoring an SOC of a cell 26 and controlling switches 28 and DC-DC converter 30, cells 26 of source/sink battery 33 may be balanced.

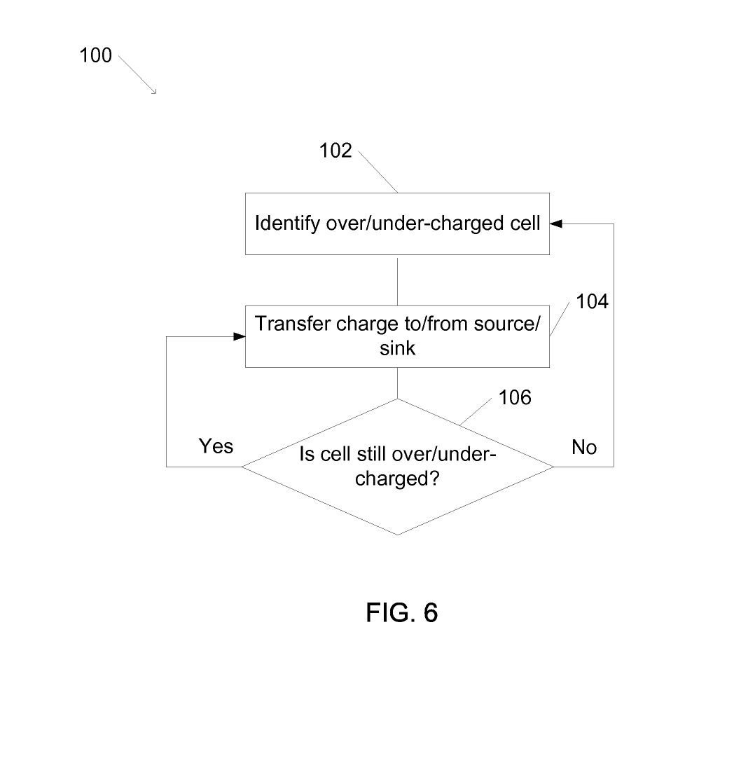

FIG. 6 is a flowchart of a method for active cell balancing via a charge source/sink, in accordance with an embodiment of the present invention. For example, the charge source/sink may include one or more of a UC, an LV bus, or an HV bus.

In accordance with source/sink cell balancing method 100, a controller identifies a cell of a battery pack that is overcharged or undercharged (block 102). For example, the controller may continually monitor cells of the battery pack in accordance with a sequence or methodology, e.g., by iterating. For example, a sequence or methodology may be based on a physical architecture of the battery pack, may be randomly selected, may be based an amount of deviation from a representative SOC, or may be based on a history of previous measurements or actions performed with regard to cell balancing. Monitoring the cells includes measuring the SOC of each of the cells (e.g. by a method that includes measuring a voltage of the cell). If the SOC of a monitored cell is greater than a representative SOC of the battery pack (e.g. an average SOC of the cells of the battery pack), the cell may be considered to be overcharged. Similarly, if the SOC of a cell is less than the representative SOC of the battery pack, the cell may be considered to be undercharged. In other embodiments a representative SOC may be other than an average SOC.

The controller then may control circuitry in the battery pack (e.g. switches and DC-DC converter) to discharge an identified overcharged cell while transferring the excess charge to the charge source/sink, or by charging an identified undercharged cell while transferring charge from the charge source/sink (block 104). Typically, the DC-DC converter is controlled such that the current, voltage, and/or duration of the charge transfer is such as to change the cell SOC to the representative SOC (or a value close to the representative SOC, e.g. within a threshold range).

After the charge transfer (or concurrently with it—e.g. by integrating a measured current flow between the cell and the charge source/sink), the SOC of the cell may be revaluated (block 106). If the cell remains overcharged or undercharged, the transfer of charge may resume or be continued (return to block 104). If the SOC of the cell is now equal to (e.g. is within a threshold value of, or is substantially equal to, or is not substantially different from) the representative SOC, the controller may search the battery pack to identify another overcharged or undercharged cell (returning to block 102).

In accordance with an embodiment of the invention, cell balancing may include charging and discharging an ultra-capacitor (UC). For example, a capacitor may be considered to be a UC if its capacitance is much greater (e.g. two or more orders of magnitude than) a typical capacitor of similar size. For example, a UC may include an electric double-layer capacitor (EDLC). The UC may be utilized as a charge source/sink (such as source/sink 34 in FIG. 5). Excess charge from an overcharged cell may be discharged from the overcharged cell to the UC, and missing charge for an undercharged cell may be obtained by discharging the UC to the undercharged cell.

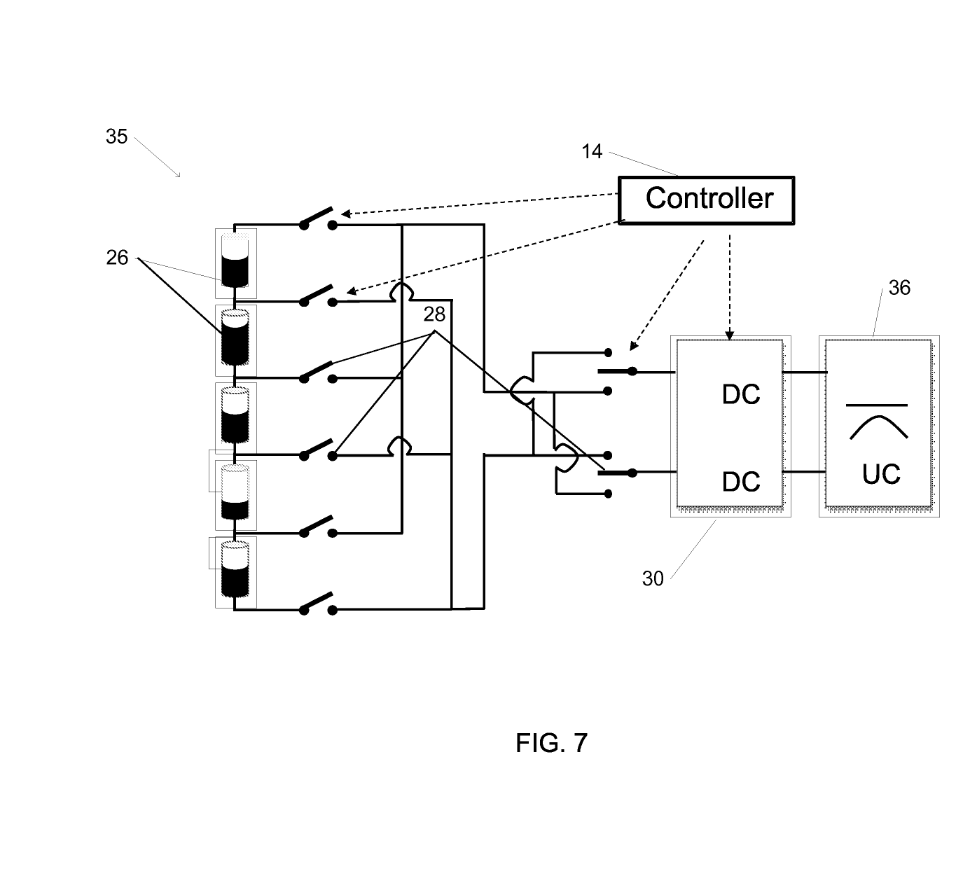

FIG. 7 is a schematic diagram of a system for active cell balancing utilizing an ultra-capacitor, in accordance with an embodiment of the present invention.

UC battery 33 may include or be associated with UC 34. Switches 28 may be controllable by controller 14 to connect at least one of cells 26 to UC 34 via

DC-DC converter 30. DC-DC converter 30 may be controlled in conjunction with switches 28 to discharge a cell 26 while charging UC 34, e.g. when the cell 26 is overcharged. Similarly, DC-DC converter 30 and switches 28 may be controlled to discharge UC 34 while charging a cell 26, e.g. when the cell 26 is undercharged. Thus, by monitoring an SOC of a cell 26 and controlling switches 28 and DC-DC converter 30, cells 26 of UC battery 33 may be balanced.

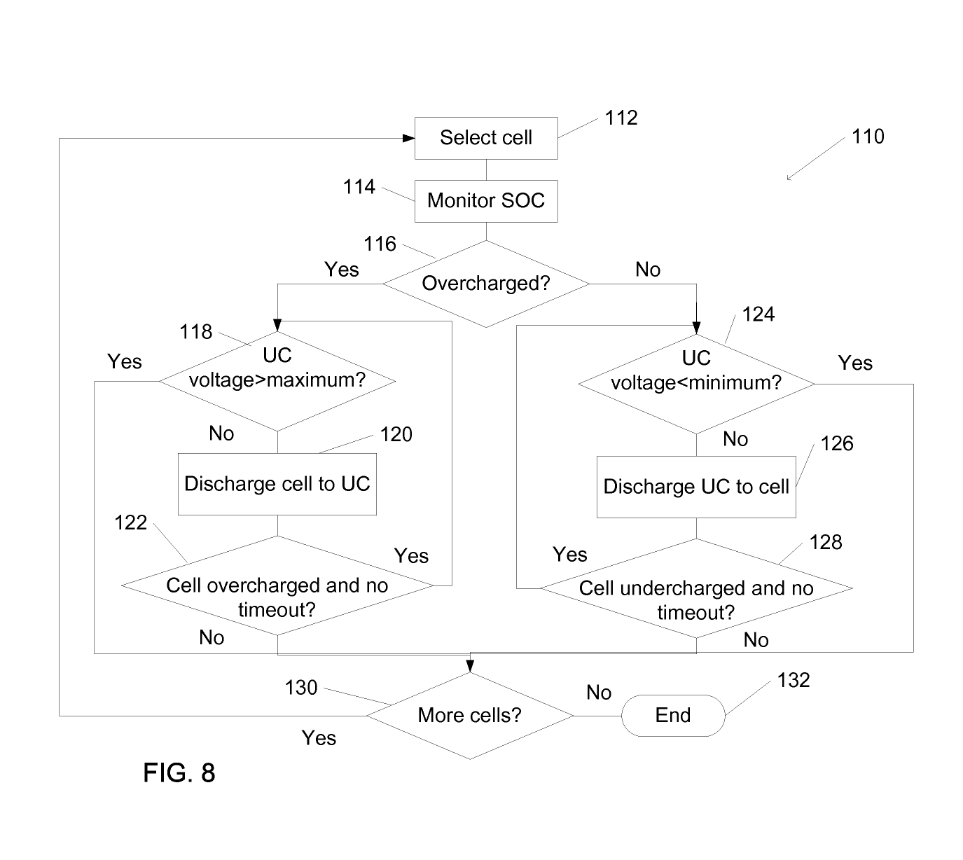

FIG. 8 is a flowchart of a method for active cell balancing using an ultra-capacitor, in accordance with an embodiment of the present invention. In accordance with UC cell balancing method 110, a controller may select a cell of a battery pack to monitor (block 112). For example, the selection of the cell may be made in accordance with a predetermined sequence of cells, or may be in accordance with a sequence that may be modified during operation, e.g. on the basis of previous actions or measurements. The SOC (or a quantity related to the SOC) of the cell may then be monitored or measured (block 114). For example, one or more of a voltage or current output of the cell may be measured over a period of time. The monitored SOC of the cell may then be compared to a representative SOC of the battery pack (block 116). For example, the representative SOC of the battery pack may be an average SOC of all of the cells (e.g. derived from a measurement of an SOC-related quantity of the battery pack as a whole).

If the cell SOC is greater than the representative SOC (e.g., overcharged), the voltage of the UC may be compared to a maximum voltage limit or threshold for the UC (block 118). For example, the maximum UC voltage limit may be determined by limitations of the capacity of the UC, or by an efficiency of charge transfer to the UC. If the UC voltage is above the maximum, no charge may be transferred from the currently selected cell to the UC. Thus, if more cells of the battery pack remain to be monitored (skip to block 130), another cell may be selected (return to block 112). On the other hand, if the UC voltage is below the maximum UC voltage limit, the controller may operate switches and a DC-DC converter to discharge the selected cell to the UC (block 120). Thus, excess charge of an overcharged cell may be transferred to the UC. The transfer of charge to the UC may be monitored. For example, monitoring of the charge transfer may include one or more of monitoring a current of the charge transfer, monitoring a voltage of the cell, and timing the charge transfer. A time limit or threshold may be imposed on the charge transfer. If monitoring of the charge transfer indicates that the cell remains overcharged and the time of the transfer does not exceed the time limit or threshold (block 122), charge transfer may continue (returning to block 118). On the other hand, if the cell is no longer overcharged or the time limit has been exceeded, another cell may be selected if more remain to be monitored (block 130 and return to block 112).

If the cell SOC is less than the representative SOC (undercharged), the voltage of the UC may be compared to a minimum voltage limit for the UC (block 124). For example, the minimum UC voltage limit or threshold may be determined by limitations on the efficiency of charge transfer from the UC. If the UC voltage is below the minimum, no charge is available for transfer to the currently selected cell from the UC. Thus, if more cells of the battery pack remain to be monitored (skip to block 130), another cell may be selected (return to block 112). On the other hand, if the UC voltage is above the minimum UC voltage limit, the controller may operate switches and a DC-DC converter to discharge the UC to the selected cell (block 126). Thus, the charge of an undercharged cell may be supplemented by charge that is transferred from the UC. The transfer of charge from the UC may be monitored. If monitoring of the charge transfer indicates that the cell remains undercharged and the time of the transfer does not exceed the time limit (block 128), charge transfer may continue (returning to block 124). On the other hand, if the cell is no longer undercharged or the time limit or threshold has been exceeded, another cell may be selected if more remain to be monitored (block 130 and return to block 112).

If no more cells remain to be selected, UC cell balancing method 110 may end (block 132). UC cell balancing method 110 may then be executed again. Thus, any overcharged or undercharged cells that were not balanced during execution of UC cell balancing method 110, e.g. due to UC voltage limits, may be balanced during a subsequent execution of UC cell balancing method 110.

In accordance with an embodiment of the present invention, the UC may be connected to a charging/discharging circuit. In this manner, the voltage of the UC may be maintained at all times within a voltage range suitable for being either charged or discharged in order to balance the cells of the battery pack. For example, the UC may be connected via a second DC-DC converter to an LV bus. For example, the LV bus may be maintained as part of the circuitry of a vehicle in which the battery pack is installed.

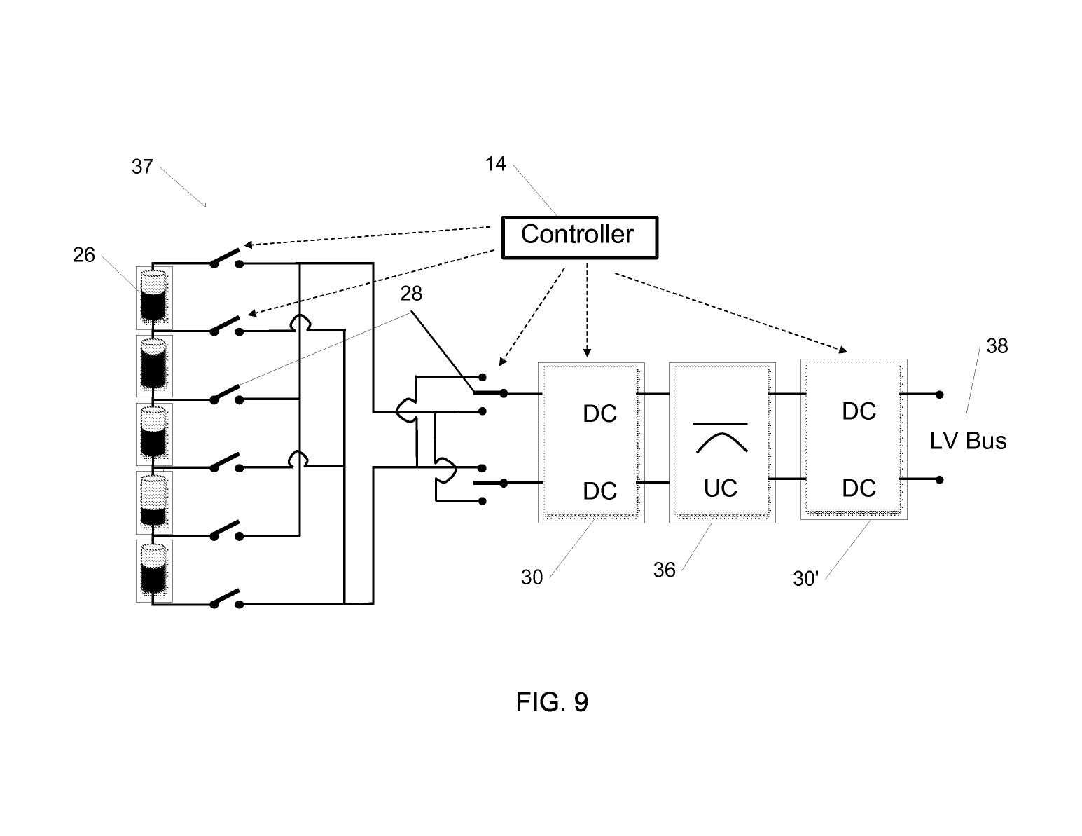

FIG. 9 is a schematic diagram of a system for active cell balancing utilizing an ultra-capacitor connected to a low voltage (LV) bus, in accordance with an embodiment of the present invention. In UC battery 37, UC 36 (which may be external to, but connected to, UC battery 37) is connected via DC-DC converter 30′ to LV bus 38. Thus, controller 14 may control DC-DC converter 30′ to charge UC 36 from LV bus 38 in order to increase the voltage of (e.g. by increasing the stored charge in) UC 36. Similarly, controller 14 may control DC-DC converter 30′ to discharge UC 36 to LV bus 38 in order to decrease the voltage of (e.g. by decreasing the stored charge in)UC 36. One, two, or other numbers of DC-DC converters may be used in this and other embodiments.

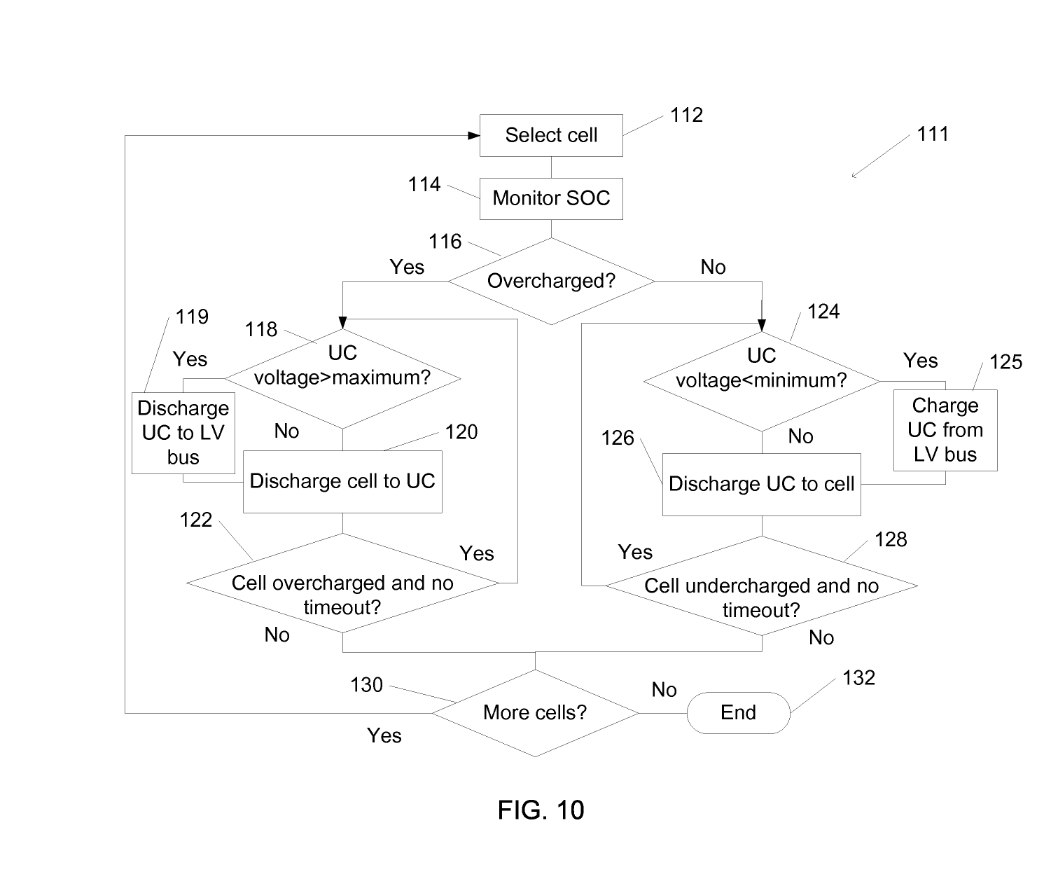

FIG. 10 is a flowchart of a method for active cell balancing using an ultra-capacitor connected to an LV bus, in accordance with an embodiment of the present invention.

LV bus-UC cell balancing method 111 may be similar to UC cell balancing method 110 (FIG. 8). However, in LV bus-UC cell balancing method 111, when a selected cell (block 112) is measured to be overcharged (blocks 114 and 116) and the UC voltage is above the maximum UC voltage limit or threshold (block 118), the UC may be discharged to the LV bus (block 119) until the UC voltage is below the maximum UC voltage limit. The overcharged cell may then be discharged to the UC (block 120) and the process continued (blocks 122, 130, and 132). Similarly, in LV bus-UC cell balancing method 111, when a selected cell (block 112) is measured to be undercharged (blocks 114 and 116) and the UC voltage is below the minimum UC voltage limit (block 124), the UC may be charged from the LV bus (block 125) until the UC voltage is above the minimum UC voltage limit. The undercharged cell may then be charged from the UC (block 126) and the process may continue (blocks 128, 130, and 132).

Thus, in one embodiment, all cells of the battery pack may be balanced during a single execution of LV bus-UC cell balancing method 111. Thus, efficiency of the cell balancing may be increased.

In accordance with an embodiment of the invention, cell balancing may include connecting each cell to an LV bus. The LV bus may be utilized as a charge source/sink. Excess charge from an overcharged cell may be discharged from the overcharged cell to the LV bus. Similarly, deficient charge for an undercharged cell may be obtained by obtaining charge from the LV bus.

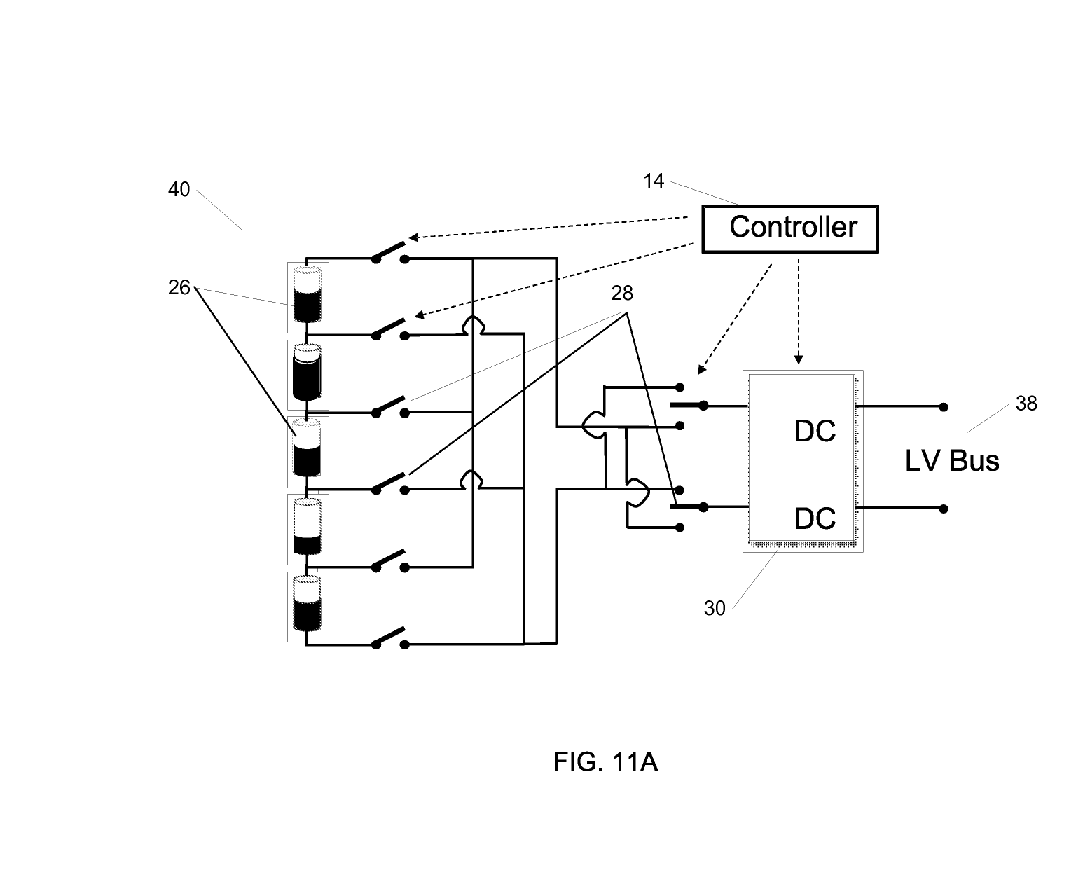

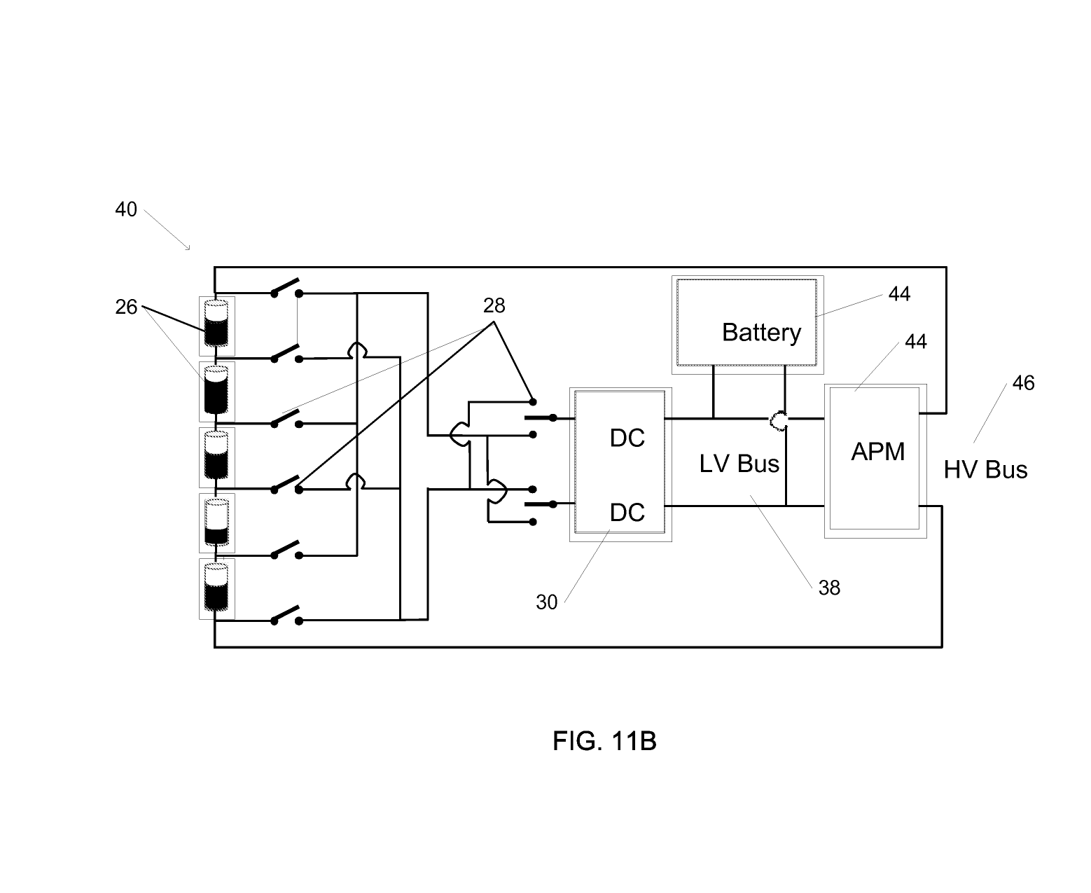

FIG. 11A is a schematic diagram of a system for active cell balancing utilizing an LV bus, in accordance with an embodiment of the present invention.

In LV bus-connected battery 40, switches 28 are controllable by controller 14 to connect at least one of cells 26 to LV bus 38 via DC-DC converter 30. DC-DC converter 30 may be controlled in conjunction with switches 28 to discharge a cell 26 to LV bus 38, e.g. when the cell 26 is overcharged. Similarly, DC-DC converter 30 and switches 28 may be controlled to charge a cell 26 from LV bus 38, e.g. when the cell 26 is undercharged. Thus, by monitoring an SOC of a cell 26 and controlling switches 28 and DC-DC converter 30, cells 26 of LV bus-connected battery 40 may be balanced.

FIG. 11 B is a schematic diagram of an embodiment of the system for active cell balancing utilizing an LV bus shown in FIG. 11A. LV bus 38 may be connected to one or more LV voltage sources. For example, LV bus 38 may be connected to a high voltage (HV) bus 46 of a vehicle (e.g. for providing locomotive power to the vehicle) via an auxiliary power module (APM) 44. Alternatively or in addition, LV bus 38 may be connected to external battery 44 (e.g. a 12 V lead acid battery).

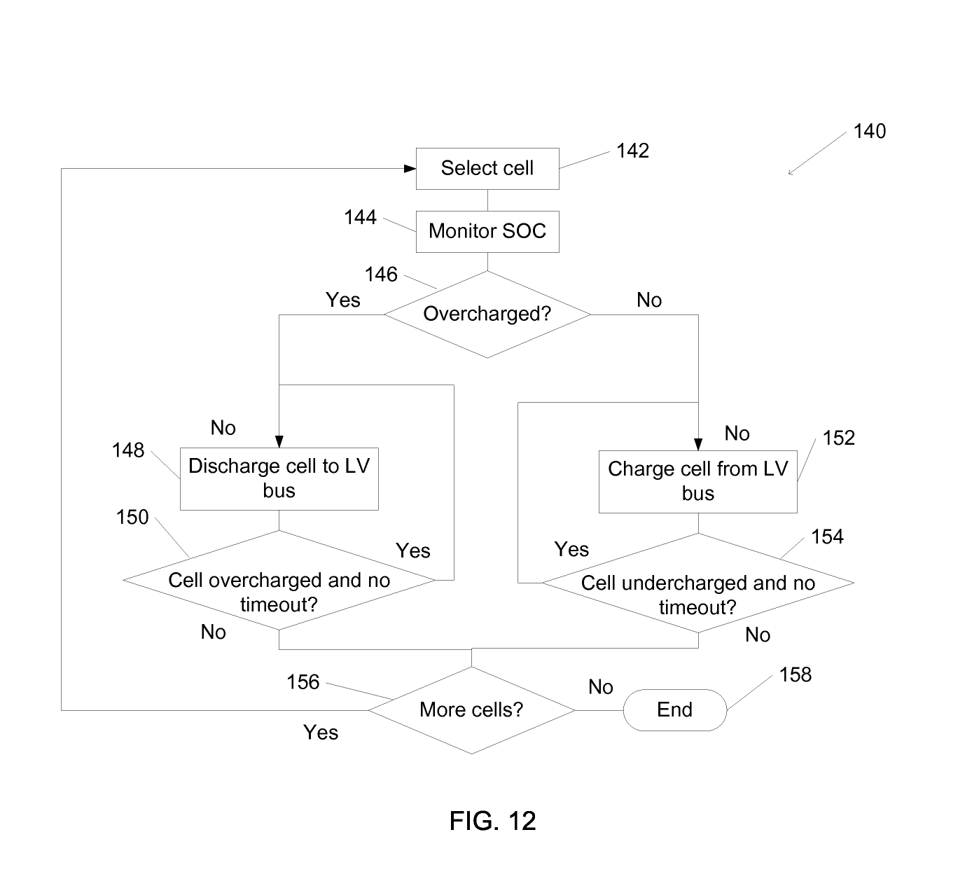

FIG. 12 is a flowchart of a method for active cell balancing using an LV bus, in accordance with an embodiment of the present invention.

In accordance with LV bus cell balancing method 140, a controller selects a cell of a battery pack to monitor (block 142). The SOC (or a quantity related to the SOC, e.g. a voltage) of the cell may then be monitored (block 144). For example, one or more of a voltage or current output of the cell may be measured. The monitored SOC of the cell may then be compared to a representative SOC of the battery pack (block 146).

If the cell SOC is greater than the representative SOC (e.g., overcharged), the controller may operate switches and a DC-DC converter to discharge the selected cell to the LV bus (block 148). Thus, excess charge of an overcharged cell may be transferred to the LV bus. The transfer of charge to the

LV bus may be monitored. For example, monitoring of the charge transfer may include one or more of monitoring a current of the charge transfer, monitoring a voltage of the cell, and timing the charge transfer. A time limit or threshold may be imposed on the charge transfer. If monitoring of the charge transfer indicates that the cell remains overcharged and the time of the transfer does not exceed the time limit (block 150), charge transfer may continue (returning to block 148). On the other hand, if the cell is no longer overcharged or the time limit has been exceeded, another cell may be selected if more remain to be monitored (block 156 and return to block 142).

If the cell SOC is less than the representative SOC (e.g., undercharged), the controller may operate switches and a DC-DC converter to charge the selected cell from the LV bus (block 152). Thus, the charge of an undercharged cell may be supplemented by charge that is transferred from the LV bus. The transfer of charge from the LV bus may be monitored. If monitoring of the charge transfer indicates that the cell remains undercharged and the time of the transfer does not exceed the time limit (block 154), charge transfer may continue (returning to block 152). On the other hand, if the cell is no longer undercharged or the time limit has been exceeded, another cell may be selected if more remain to be monitored (block 156 and return to block 142).

If no more cells remain to be selected, LV bus cell balancing method 140 may end (block 158). LV bus cell balancing method 140 may be executed repeatedly periodically at predetermined intervals, or in response to a predetermined event. LV bus cell balancing method 140 may be executed continually, e.g. executing LV bus cell balancing method 140 immediately after a previous execution of LV bus cell balancing method 140 is complete.

In accordance with an embodiment of the invention, a high voltage (HV) bus may be utilized as a charge source/sink for performing cell balancing. The battery may be provided with an HV DC-DC converter. Excess charge from an overcharged cell may be discharged from the overcharged cell via the HV DC-DC converter to the HV bus. Similarly, deficient charge for an undercharged cell may be obtained by obtaining charge from the HV bus via the HV DC-DC converter.

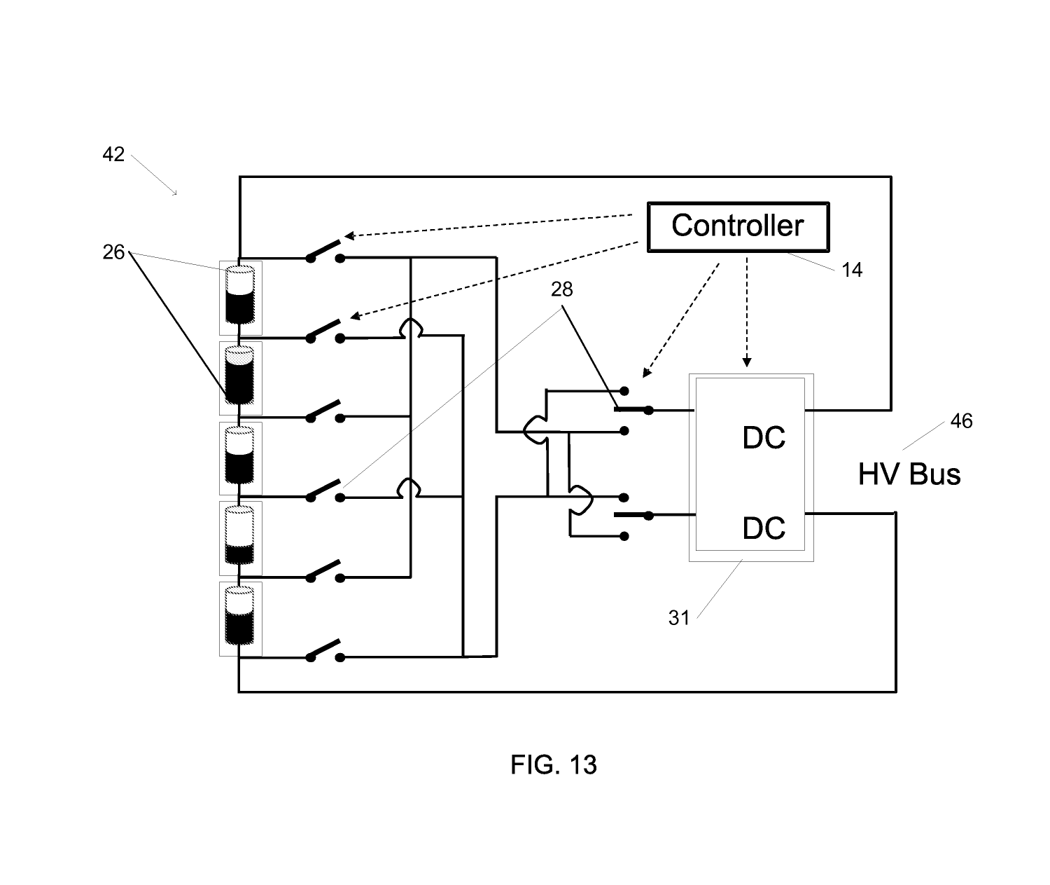

FIG. 13 is a schematic diagram of a system for active cell balancing utilizing a high voltage (HV) bus, in accordance with an embodiment of the present invention.

In HV bus-connected battery 42, switches 28 are controllable by controller 14 to connect at least one of cells 26 to HV bus 46 via HV DC-DC converter 31. HV DC-DC converter 31 may be controlled in conjunction with switches 28 to discharge a cell 26 to HV bus 46, e.g. when the cell 26 is overcharged. Similarly, HV DC-DC converter 31 and switches 28 may be controlled to charge a cell 26 from HV bus 46, e.g. when the cell 26 is undercharged. Thus, by monitoring an SOC of a cell 26 and controlling switches 28 and HV DC-DC converter 31, cells 26 of HV bus-connected battery 42 may be balanced.

Embodiments of the present invention may include apparatuses for performing the operations described herein. Such apparatuses may be specially constructed for the desired purposes, or may include computers or processors selectively activated or reconfigured by a computer program stored in the computers. Such computer programs may be stored in a computer-readable or processor-readable storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

1. A method comprising:
identifying an overcharged cell from among a plurality of cells of a battery pack;
identifying an undercharged cell from among any of the plurality of cells of the battery pack;
operating a switch to connect the overcharged cell to the undercharged cell via a direct current (DC)-DC converter; and
operating the DC-DC converter to transfer charge from the overcharged cell to the undercharged cell.

2. The method of claim 1, wherein identifying the overcharged cell and the undercharged cell comprises monitoring a voltage of each of the cells.

3. The method of claim 1, wherein identifying the overcharged cell and the undercharged cell comprises sequentially monitoring each cell of the plurality of cells.

4. The method of claim 1, wherein identifying the overcharged cell comprises measuring a cell state of charge (SOC) that is greater than an average SOC of the cells of the battery pack, and wherein identifying the undercharged cell comprises measuring a cell SOC that is less than the average SOC.

5. The method of claim 1, wherein operating the DC-DC converter comprises controlling a current, voltage and duration of the charge transfer so as to change the SOC of one of the identified cells to be substantially equal to a representative SOC of the cells of the battery pack.

6. A method comprising:
selecting a cell from among cells of a battery pack;
determining a state of charge (SOC) of the selected cell;
if the SOC of the selected cell is different from a representative SOC of the cells of the battery pack, operating a switch to connect the selected cell to a charge source/sink via a DC-DC converter;
if the SOC of the selected cell is greater than the representative SOC, operating the DC-DC converter to discharge the selected cell to the charge source/sink; and
if the SOC of the selected cell is less than the representative SOC, operating the DC-DC converter to charge the selected cell from the charge source/sink.

7. The method of claim 6, wherein the representative SOC comprises an average SOC of the cells of the battery pack.

8. The method of claim 6, wherein selecting the cell comprises sequentially selecting each of the cells.

9. The method of claim 6, wherein the charge source/sink comprises an ultra-capacitor (UC).

10. The method of claim 9, wherein the cell is discharged to the UC only if a voltage of the UC is less than a maximum voltage level, and wherein the cell is charged from the UC only if the voltage of the UC is greater than a minimum voltage level.

11. The method of claim 10, comprising operating a second DC-DC converter to discharge the UC to a low voltage (LV) bus when the UC voltage is greater than the maximum voltage level, and operating the second DC-DC converter to charge the UC from the LV bus when the UC voltage is less than the minimum voltage level.

12. The method of claim 6, wherein the charge source/sink comprises an LV bus.

13. The method of claim 6, wherein the charge source/sink comprises a high voltage bus, and wherein the DC-DC converter comprises a high voltage DC-DC converter.

14. The method of claim 6, wherein operating the DC-DC converter comprises controlling a current , voltage, and duration of the charge transfer so as to change the SOC of the selected cell to be substantially equal to the representative SOC.

15. The method of claim 6, wherein if the SOC of the selected cell is greater than the representative SOC, the charge source/sink comprises another of the cells whose SOC is less than the representative SOC, and if the SOC of the selected cell is less than the representative SOC, the charge source/sink comprises another of the cells whose SOC is greater than the representative SOC.

16. A system comprising:
a plurality of switches;
a direct current (DC)-DC converter; and
a controller to identify an overcharged cell from among a plurality of cells of a battery pack, to identify an undercharged cell from among any of the plurality of cells of the battery pack, to operate at least a switch of the plurality of switches to connect the overcharged cell to the undercharged cell via the DC-DC converter, and operate the DC-DC converter to transfer charge from the overcharged cell to the undercharged cell.

17. The system of claim 16, incorporated in an electrically powered vehicle.

18. The system of claim 16, wherein the switch comprises a metal-oxide-semiconductor field-effect transistor (MOSFET) or an insulated gate bipolar transistor (IGBT).

19. The system of claim 16, wherein the plurality of switches is operable to connect each cell of the plurality of cells individually to any of at least two connectors of the DC-DC converter.

20. The system of claim 16, wherein the plurality of switches is operable to connect two different cells of the plurality of cells to different connectors of the DC-DC converter.
